(19) United States
(12) Patent Application Publication
(10) Pub. No.: US 2018/0225882 A1
(43) Pub. Date: Aug. 9, 2018

(54) METHOD AND DEVICE FOR EDITING A FACIAL IMAGE

(71) Applicants: Kiran VARANASI, Saarbruecken (DE); Praveer Singh, Faridabad (IN); Francois LeClerc, L'Hermitage (FR)

(72) Inventors: Kiran VARANASI, Saarbruecken (DE); Praveer Singh, Faridabad (IN); Francois LeClerc, L'Hermitage (FR)

(21) Appl. No.: 15/506,754

(22) PCT Filed: Aug. 24, 2015
(86) PCT No.: PCT/EP2015/069306

§ 371 Date: Feb. 27, 2017

(30) Foreign Application Priority Data
Aug. 29, 2014 (EP) 14306336.0
Jun. 10, 2015 (EP) 15305883.9

(51) Int. Cl. G06T 19/20; G06T 11/60; G06T 17/20; G06T 7/33

(52) U.S. Cl. CPC G06T 19/20; G06T 11/60; G06T 2207/30201; G06T 7/337; G06T 2219/2021; G06T 17/20

(57) ABSTRACT

The invention concerns a method for editing facial expressions in images comprising editing a 3D mesh model of the face to modify a facial expression and generating a new image corresponding to the modified model to provide an image with a modified facial expression.

### TECHNICAL FIELD

The present invention relates to a method and device for editing an image. Particularly, but not exclusively, the invention relates to a method and device for editing facial expressions in images.

### BACKGROUND

Faces are important subjects in captured images and video. A person's face may be captured in a variety of settings, such as posing in an indoor party setting or in front of a tourist attraction. Typically, however the person's facial expression is often not appropriately captured to suit the situation. In such cases, photo-editing software is required to modify the facial expression. Additional images may be required in order to synthesize a new expression, for example, to make the person open their mouth or to smile. This is a tedious job however and requires a lot of time and skill from the user. At the same time, editing facial expressions is one of the most common photo-editing requirements.

In the context of a video, editing facial expressions is even harder, such that the edits do not cause temporal artefacts and jitter. Typically, an exact 3D model is required to be registered at each time step, which needs specialized capture setups or sophisticated algorithms that take significant computational time.

The present invention has been devised with the foregoing in mind.

### SUMMARY

In a general form the invention concerns a method for editing facial expressions in images comprising editing a 3D mesh model of the face to modify a facial expression and generating a new image corresponding to the modified model to provide an image with a modified facial expression.

An aspect of the invention provides a method for collecting texture database of multiple face regions by registering a common mesh template model to a captured face video.

Another aspect of the invention provides a method for producing a composite image by choosing the most appropriate facial expression in different face regions.

Another aspect of the invention provides a method for applying localized warps to correct for projective transformations in the synthesized composite image

Another aspect of the invention provides a method for organizing and indexing a face texture database and choosing the closest texture that corresponds to a facial expression.

Another aspect of the invention provides a method for performing RGB face image editing, by manipulating a 3D face model as a proxy.

Another aspect of the invention provides a method for simultaneously bringing multiple face images into the same facial pose by editing a 3D face model as a proxy.

Another aspect of the invention concerns a method for editing facial expressions in images comprising:

parameterizing deformation space of the face using a blendshape model;

building a database of image textures from various facial regions in correspondence with 3D facial expression changes;

generating a new facial image by composition of suitable image textures from different facial regions, retrieved from the database.

Another aspect of the invention provides a method of editing an image depicting a facial expression, the method comprising:

providing a database of image patches of different facial regions;

editing a facial model registered with the image to be edited; selecting patches from the database according to the modifications, and generating a composite image from the patches.

Another aspect of the invention provides a device for editing a facial expression in an image, the device comprising memory and at least one processor in communication with the memory, the memory including instructions that when executed by the processor cause the device to perform operations including: editing a 3D mesh model of the face to modify a facial expression and; generating a new image corresponding to the modified model to provide an image with a modified facial expression.

Another aspect of the invention provides a device for editing a facial expression in an image, the device comprising memory and at least one processor in communication with the memory, the memory including instructions that when executed by the processor cause the device to perform operations including:
accessing a database of image patches of different facial regions;
modifying a facial model registered with the image to be edited selecting patches from the database according to the modifications, and
generating a composite image from the patches.

Embodiments of the invention provide a method for editing face videos that are captured with a simple monocular camera. In a pre-processing stage, it is assumed that a face tracking algorithm is applied on the video and a 3D mesh model is registered across time over the facial expressions. Then in run time, the user directly edits the 3D mesh model of the face and synthesizes a novel visual image that corresponds to the 3D facial expression. The deformation space is parameterized using a linear blendshape model and collecting a database of image textures from various facial regions in correspondence with 3D expression changes. A novel face image is generated by compositing the most appropriate textures from the different face regions by referring to the database. In this way, a rapid way to edit and synthesize novel facial expressions in a given input face image is provided.

There are several applications for face model based video editing. Home videos and photographs taken by general consumers can be edited in a fast and easy way to show new facial expressions. The face synthesis technique according to embodiments of the invention can also be applied for editing actor's expressions for the post-production of films. There are applications also in psychological studies and in the creation of virtual human avatars as communication agents.

Some processes implemented by elements of the invention may be computer implemented. Accordingly, such elements may take the form of an entirely hardware embodiment, an entirely software embodiment (including firmware, resident software, micro-code, etc.) or an embodiment combining software and hardware aspects that may all generally be referred to herein as a “circuit”, “module” or “system”. Furthermore, such elements may take the form of a computer program product embodied in any tangible medium of expression having computer usable program code embodied in the medium.

Since elements of the present invention can be implemented in software, the present invention can be embodied as computer readable code for provision to a programmable apparatus on any suitable carrier medium. A tangible carrier medium may comprise a storage medium such as a floppy disk, a CD-ROM, a hard disk drive, a magnetic tape device or a solid state memory device and the like. A transient carrier medium may include a signal such as an electrical signal, an electronic signal, an optical signal, an acoustic signal, a magnetic signal or an electromagnetic signal, e.g. a microwave or RF signal.

### BRIEF DESCRIPTION OF THE DRAWINGS

Embodiments of the invention will now be described, by way of example only, and with reference to the following drawings in which:

FIG. 1 is a flow chart illustrating steps of method of editing an image in accordance with an embodiment of the invention;

FIG. 2 illustrates an example of a collection of textures in a database for different facial regions and over different expressions in accordance with an embodiment of the invention;

FIG. 3 illustrates changing of a facial expression on a 3D mesh model by dragging vertices, in accordance with an embodiment of the invention;

FIG. 4 illustrates an example of selected patches in different regions that correspond to a user edit;

FIG. 5 illustrates examples of the synthesis of novel facial expressions in accordance with an embodiment of the invention;

FIG. 6 illustrates examples synthesis of novel facial expressions in different actors in accordance with an embodiment of the invention; and

FIG. 7 illustrates an image processing device in accordance with an embodiment of the invention.

### DETAILED DESCRIPTION

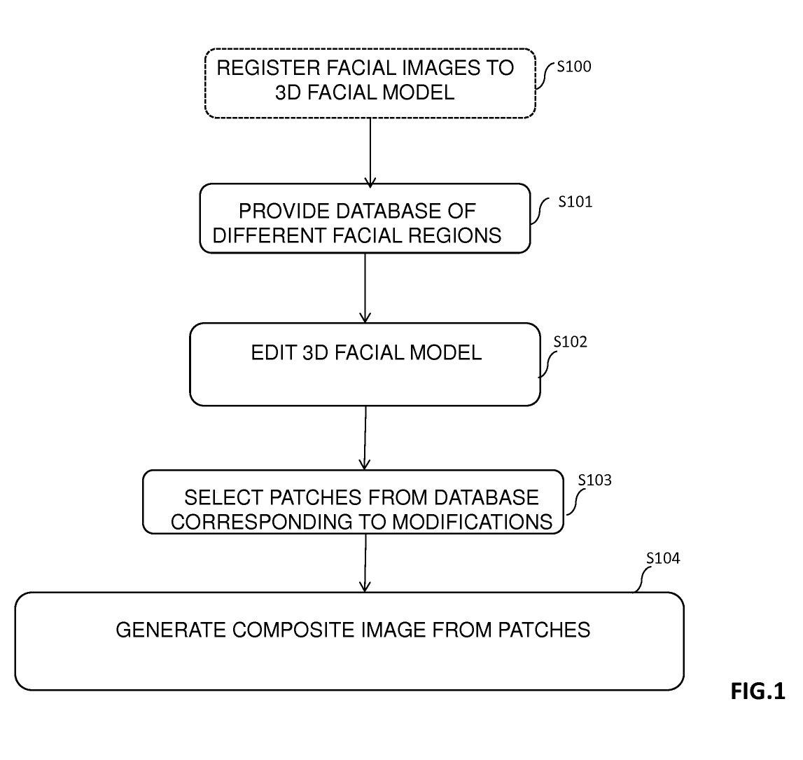

FIG. 1 is a flow chart illustrating steps of method of editing an image depicting a facial expression in accordance with an embodiment of the invention

In step S101 a texture database of facial image patches corresponding to different facial regions over a range of facial expressions is built by using a facial-model-image registration method performed in a pre-processing step S100.

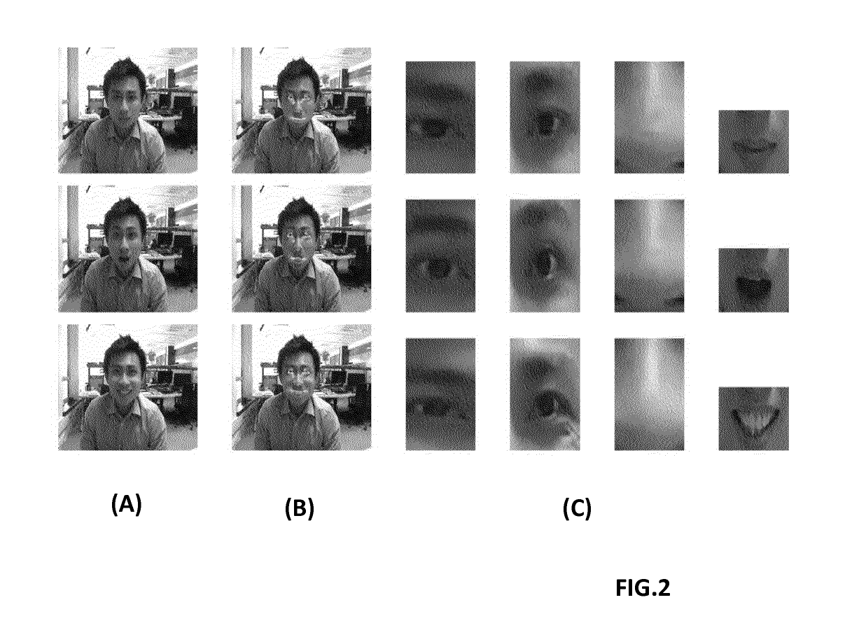

The facial model image registration method applied in step S100 includes inputting a monocular face video sequence of captured images of a face and tracking facial landmarks of the face in the sequence of images. The sequence of images captured depict a range of facial expressions over time including, for example, facial expressions of anger, surprise, laughing, talking, smiling, winking, raised eyebrow(s) as well as normal facial expressions. An example of a sequence of images is illustrated in column (A) of FIG. 2.

A sparse spatial feature tracking algorithm, for example, may be applied for the tracking of the facial landmarks (for example the tip of the nose, corners of the lips, eyes etc.)through the sequence of images. An example of facial landmarks is indicated in the images of column (B) of FIG. 2. The tracking of facial landmarks produces camera projection matrices at each time-step (frame) of the video sequence as well as a sparse set of 3D points showing the different facial landmarks.

The process includes applying a 3D mesh blendshape model of a human face that is parameterized to blend between different facial expressions. Each of these facial expressions is referred to as blendshape target. A weighted linear blend between the blendshape targets produces an arbitrary facial expression.

Formally, the face model is represented as a column vector F containing all the vertex coordinates in some arbitrary but fixed order as xyzxyz . . . xyz.

Similarly the kth blendshape target can be represented by bₖ, and the blendshape model is given by:

$$F = {\sum }_{k}^{ } {w}_{k} {b}_{k}$$

Any weight wₖ basically defines the span of the blendshape target bₖ and when combined together they define the range of expressions over the modeled face F. All the blendshape targets can be placed as columns of a matrix B and the weights aligned in a single vector w, thus resulting in a blendshape model given as:

F=Bw

Consequently a 3D face model F is obtained which after being subjected to some rigid and non-rigid transforms, can be registered on top of the sparse set of 3D facial landmarks previously obtained

A method is then applied to register this 3D face blendshape model to the previous output of sparse facial landmarks, where the person in the input video has very different physiological characteristics as compared to the mesh template model.

An example of texture image patches collected is shown in columns (C) of FIG. 2. Each of these textures are annotated with the exact facial expression represented by the blending weights w_{c} of the registered facial blendshape model at that time-step (frame). The aim is to synthesize a new facial image corresponding to a novel facial expression, by looking up this texture database and compositing an image from different texture image patches. The most appropriate texture image patch according to a modification of the face model for the change of facial expression is selected for each facial region by selecting the nearest neighbor in the database with respect to the registered facial expression. This involves selecting an image patch from a frame of a particular modified neighbourhood whose blendshape weights (for only a subset of blendshape weights that affect the neighbourhood) are the closest to the current blendshape weights It may be noted that the chosen time-step for picking the texture/facial image patch can vary across different facial regions.

It will be explained how this database of neighborhood patches is built for every frame in the video. For each frame of the video, each of the non-overlapping neighborhoods (for example 4 in total) is projected into the image and then cropped out as rectangular patches. The end points of this rectangular patch are computed by using the extremities of the projected neighborhood.

Thus using these neighborhood patches generated for every frame of the video, a whole database (as shown in FIG. 2) is built for every non overlapping region/neighborhood (4 in total) for all possible frames in the video.

Thus for the i^{th} neighborhood, i=1,2,3,4, and K^{th} frame, a corresponding patch is given by p_{Ki}.

As a next step, in order to retrieve the best resembling neighborhood patch a least square minimization technique is applied which provides the frame where the components (which have a direct influence on a particular neighborhood) weights are the closest to the current weights. But before this we two sets of lists are created. The first list indicates which component (blendshape target) is affecting which corresponding neighborhood. Thus, if the j^{th} blendshape target bⱼ is affecting the i^{th} neighborhood Uᵢ, then a mapping bⱼ->Uᵢ is provided. The set of blendshape targets associated with a particular ith neighborhood is given by Aᵢ.

The second list provides the corresponding blendshape weights for all the 40 blendshape targets for every possible frame in the video. In other words information is provided on which are the most affected components per frame. The blendshape weight for a j^{th} blendshape target for the K^{th} frame can be denoted by w_{jK}.

With this database and indexing method, it can be deduced by looking at the current blendshape weights of the geometric model edited by the artist, as to which all neighborhoods are affected and secondly which is the closest frame from where we can get the most representative patch for a particular neighborhood to build the composite image.

In step S102 the editing artist makes modifications to the model in accordance with the desired editing. In step 103 image patches are selected from the database, corresponding to the modifications. Indeed, once the artist has made plausible modifications in the 3D blendshape model, a patch, from patches in different frames in the database, that best represents any modified neighborhood region is selected and fixed. This is done for all the different neighborhood regions and hence what is referred to as a composite image is obtained. Such a technique is adopted because not only does it give an effective and computationally less expensive appearance model but is also finer and a simpler way to get the desired effects in the corresponding frame of the video simply by making modification in the 3D geometric model which is in fact in a direct correlation with this appearance model.

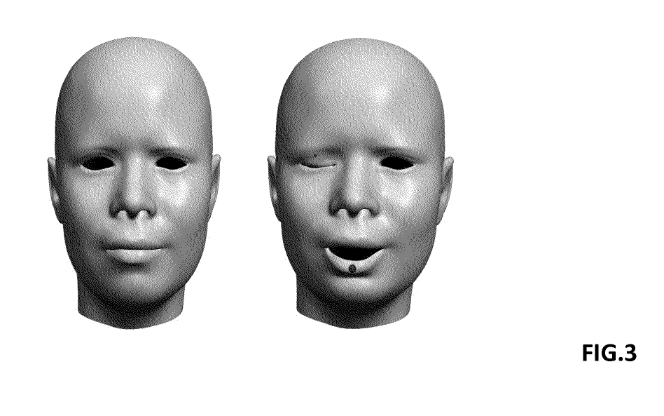

First, the artist may make some desired modifications in the 3D blendshape model illustrated in FIG. 3 again using a direct manipulation technique as described in (“Direct Manipulation Blendshapes” J. P. Lewis, K. Anjyo. IEEE Computer Graphics Applications 30 (4) 42-50, July, 2010) for example. The artist drags a few vertices and the entire face is deformed by treating them as constraints.

The algorithm according to the present embodiment of the invention computes all the possible affected blendhshape targets bⱼ and their corresponding blendshape weights wⱼ, j=1; 2; :::40. By looking in the database it also tells which all neighborhoods have been affected by the editing in the geometric model.

In the next step, the algorithm computes the closest frame which basically provides the most representative patch from the database corresponding to each of the neighborhoods that we obtained from the previous step. Thus in other words, for every neighborhood some associated blendshape targets are provided. For these associated blendshape targets, the algorithm determinest the closest frames where the associated blending weights from the database are the closest (at the minimum Euclidean distance from the current blending weights weights for the same blendshape targets). So for any particular i^{th} neighborhood, if it is assumed that the associated blendshape target weights to be given as wⱼ , where j stands for the jth component present in the list of associated components Aᵢ for the i^{th} neighborhood.

For the K^{th} frame and j^{th} blendshape target, the blending weight is given as w_{jK}. Hence, the closest frame can be computed by a performing a least squares over all possible frames in the video and is given by:

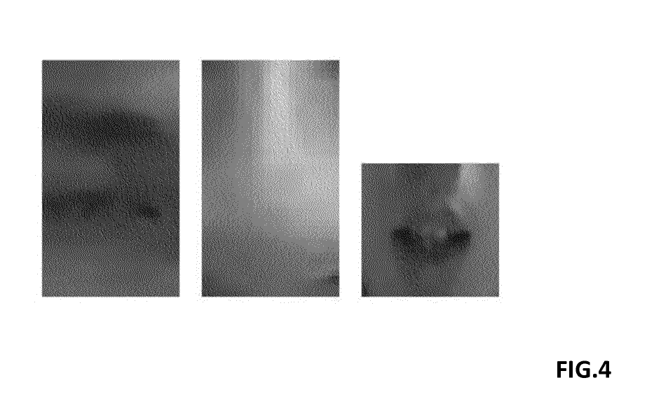

K*ᵢ=Minₖ(Σⱼ(wⱼ−w_{jK})²)

where K*ᵢ gives us the closest frame for the ith neigborhood. Next for each i^{th} neighborhood the closest frame patch given by p_{K}*ₗ is called for The resulting patches for the affected neighborhoods can be seen in FIG. 4

In step S104 a composite image is generated. This is basically done by applying the patches on the appropriate image regions/neighborhood. But before that, a slight warping algorithm is performed in order to align the patch with the current image, by correcting for projective transformations between the current frame and the chosen frame in the database. This corrective warp is given by:

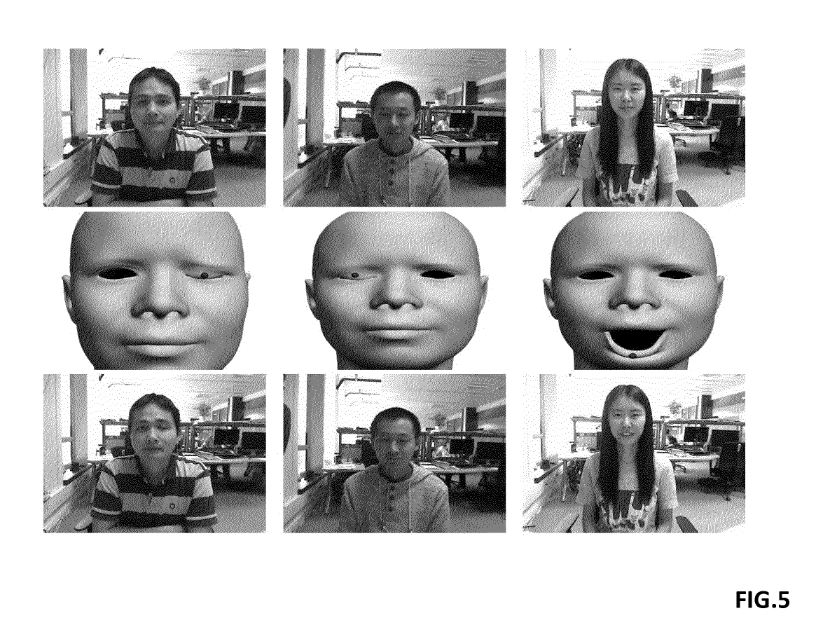

q_{K}*ᵢ=P_{c}Pₒ⁺pₖ*ᵢ

where P_{c} is the projection matrix for the current frame to which the patch is being applied, Pₒ⁺ is the pseudo inverse of the projection matrix for the original frame from which the patch pₖ*ᵢ has been chosen.
The final warped patch qₖ*ₗ is then placed at the appropriate position in the image. These final composite image is synthesized from multiple patches. They show the captured actor's face in a completely different synthesized facial expression. FIG. 5 shows an example of a collection of results for the synthesis of novel facial expressions. The top row shows the input image, the middle row shows the artistic edit on the 3D mesh model, the bottom row shows the synthesized facial composite image that corresponds to this edited expression.

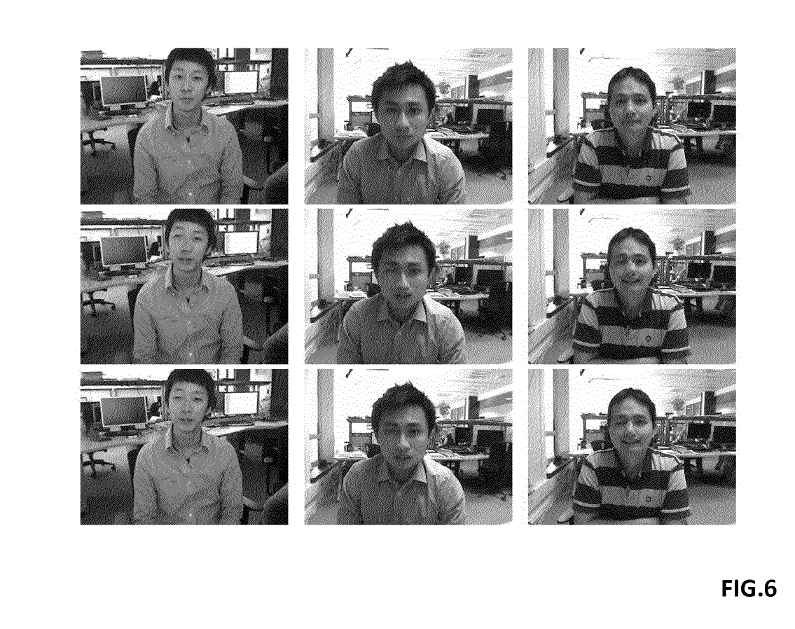

The face editing method according to embodiments of the invention can also be applied simultaneously on multiple images of different actors, producing synthesized facial images of all the actors showing the same facial expression. This is illustrated in FIG. 6 which illustrates multiple actors brought to the same facial expression. The top row shows the input image. The middle row shows the result of naïve facial compositing, without the proposed correction in accordance with embodiments of the invention for projective transformations. The bottom row shows the final composite image that is the result of a method in accordance with an embodiment of the invention.

Apparatus compatible with embodiments of the invention may be implemented either solely by hardware, solely by software or by a combination of hardware and software. In terms of hardware for example dedicated hardware, may be used, such ASIC or FPGA or VLSI, respectively«Application Specific Integrated Circuit», «Field-Programmable Gate Array», «Very Large Scale Integration», or by using several integrated electronic components embedded in a device or from a blend of hardware and software components.

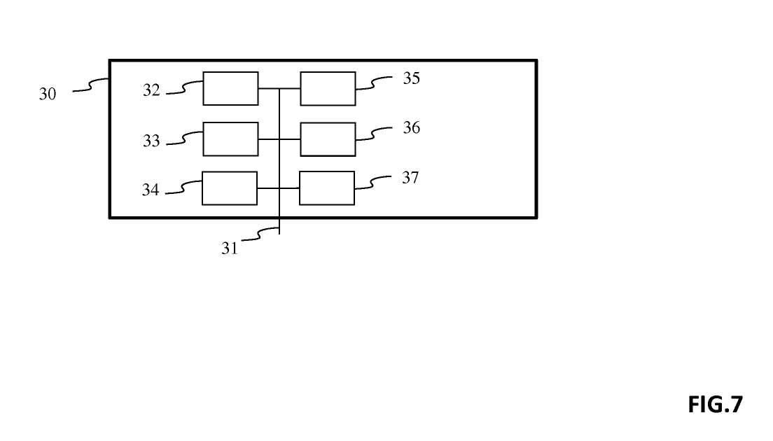

FIG. 7 is a schematic block diagram representing an example of an image processing device 30 in which one or more embodiments of the invention may be implemented. Device 30 comprises the following modules linked together by a data and address bus 31:
a microprocessor 32 (or CPU), which is, for example, a DSP (or Digital Signal Processor);
a ROM (or Read Only Memory) 33;
a RAM (or Random Access Memory) 34;
an I/O interface 35 for reception and transmission of data from applications of the device; and
a battery 36
a user interface 37

According to an alternative embodiment, the battery 36 may be external to the device. Each of these elements of FIG. 6 are well-known by those skilled in the art and consequently need not be described in further detail for an understanding of the invention. A register may correspond to area of small capacity (some bits) or to very large area (e.g. a whole program or large amount of received or decoded data) of any of the memories of the device. ROM 33 comprises at least a program and parameters. Algorithms of the methods according to embodiments of the invention are stored in the ROM 33. When switched on, the CPU 32 uploads the program in the RAM and executes the corresponding instructions to perform the methods.

RAM 34 comprises, in a register, the program executed by the CPU 32 and uploaded after switch on of the device 30, input data in a register, intermediate data in different states of the method in a register, and other variables used for the execution of the method in a register.

The user interface 37 is operable to receive user input for control of the image processing device, and editing of facial expressions in images in accordance with embodiments of the invention.

Embodiments of the invention provide that produces a dense 3D mesh output, but which is computationally fast and has little overhead. Moreover embodiments of the invention do not require a 3D face database. Instead, it may use a 3D face model showing expression changes from one single person as a reference person, which is far easier to obtain.

Although the present invention has been described hereinabove with reference to specific embodiments, the present invention is not limited to the specific embodiments, and modifications will be apparent to a skilled person in the art which lie within the scope of the present invention.

For instance, while the foregoing examples have been described with respect to facial expressions, it will be appreciated that the invention may be applied to other facial aspects or the change of other landmarks in images.

Many further modifications and variations will suggest themselves to those versed in the art upon making reference to the foregoing illustrative embodiments, which are given by way of example only and which are not intended to limit the scope of the invention, that being determined solely by the appended claims. In particular the different features from different embodiments may be interchanged, where appropriate.

1. A method of editing a facial an image depicting at least part of a face of a person with a facial expression, the method comprising:
editing a generic 3D mesh model registered with the facial image to modify the facial expression;
selecting at least one facial image patch according to the person and the edited generic 3D mesh model; and
generating a new facial image as a composition of said selected facial image patches.

2. The method according to claim 1 wherein the facial image patches are selected from a database of facial image patches collected from a sequence of captured images of the face, each facial image patch corresponding to a part of the face at a given time in the sequence.

3. The method according to claim 2 wherein the sequence of captured images is registered to a common mesh template model.

4. The method according to claim 1, comprising applying localized warps to the 3D mesh model to correct for projective transformations in the new facial image.

5. The method according to claim 1, wherein the 3D mesh model is a blendshape model parameterized to blend between different facial expressions.

6. The method according to claim 1, comprising performing RGB face image editing, by manipulating a 3D face model as a proxy.

7. The method according to claim 1, comprising simultaneously bringing multiple face images into the same facial pose by editing a 3D face model as a proxy.

8. An image editing device for editing a facial expression in an image of at least part of a face of a person, the device comprising a memory associated with at least one processor configured to:
modify a generic 3D mesh model registered with the facial image to change the facial expression;
select a plurality of facial image patches according to the person and the modified generic 3D mesh model; and
generate a new facial image as a composition of said selected facial image patches.

9. The image editing device according to claim 8, wherein the facial image patches are selected from a database of facial image patches collected from a video sequence of captured images of the face, each facial image patch corresponding to a part of the face.

10. The image editing device according to claim 9, wherein the video sequence of images is registered to a common mesh template model.

11. Aft The image editing device according to claim 8, wherein the at least one processor is configured to apply localized warps to correct for projective transformations in the new facial image.

12. The image editing device according to claim 8, wherein the at least one processor is configured to perform RGB face image editing, by manipulating a 3D face model as a proxy.

13. The image editing device according to claim 8, wherein the at least one processor is configured to simultaneously bring multiple face images into the same facial pose by editing a 3D face model as a proxy.

14. Aft The image editing device according to claim 8, wherein the 3D mesh model is a blendshape model.

15. A computer program product for a programmable apparatus, the computer program product comprising a sequence of instructions for implementing a method according to claim 1 when loaded into and executed by the programmable apparatus.
